(19) United States
(12) Patent Application Publication
(10) Pub. No.: US 2008/0069947 A1
(43) Pub. Date: Mar. 20, 2008

(54) METHOD AND APPARATUS FOR FLUX COATING OF HEAT EXCHANGER TUBE

(75) Inventors: Sang-Heon Lee, Seoul (KR); Jong-Seo Yoon, Gyeonggi-do (KR); Youn-Hak Shin, Gyeonggi-do (KR); Byoung-Kwang Lee, Gyeonggi-do (KR)

Correspondence Address: JONES DAY, 222 EAST 41ST ST, NEW YORK, NY, 10017, US

(73) Assignee: LS Cable Ltd., Seoul (KR)

(21) Appl. No.: 11/857,652

(22) Filed: Sep. 19, 2007

(30) Foreign Application Priority Data
Sep. 19, 2006 (KR) 10-2006-0090716

(51) Int. Cl. B05D 1/36; B05C 19/04; B05C 3/02

(52) U.S. Cl. 427/202; 118/114; 118/58

(57) ABSTRACT

For flux coating of a heat exchanger tube made of aluminum, firstly, the heat exchanger tube is dipped in a storage tank containing a mixture of binder and solvent to coat the mixture on a surface of the heat exchanger tube, thereby forming a first coating layer on the surface of the heat exchanger tube. Then, flux powder is sprayed to the surface of the heat exchanger tube on which the first coating layer is formed, thereby forming a second coating layer. After that, a thickness of the heat exchanger tube on which the second coating layer is formed is controlled. Then, the thickness-controlled heat exchanger tube is heated to 150° C. or below so as to remove the solvent from the second coating layer.

### BACKGROUND OF THE INVENTION

1. Field of the Invention

The present invention relates to method and apparatus for flux coating of a heat exchanger tube, and more particularly to method and apparatus for allowing uniform flux coating on a heat exchanger tube used for making a heat exchanger of a vehicle.

2. Description of the Related Art

A heat exchanger tube is a part used in a heat exchanger of a vehicle, and the heat exchanger tube is made of aluminum material in consideration of lightweight, high sensitivity, and thermal conduction. This heat exchanger tube is mounted to a heat exchanger of a vehicle such as a car to enable heat exchange at high efficiency, accordingly working for fuel reduction of the vehicle.

Commonly, a heat exchanger tube used for a heat exchanger of a vehicle is called a PFC (Parallel Flow Condenser) tube, which is made by extruding an aluminum wire into a tubular shape. The process of making a conventional heat exchanger tube will be explained with reference to FIGS. 1 and 2.

Referring to FIGS. 1 and 2, an aluminum wire 1, which is a material of a heat exchanger tube, is supplied from a bobbin 2 of a supplier. The supplied aluminum wire 1 is chemically treated in an impurity removing unit 3 such that impurities adhered on its surface are removed, and then the aluminum wire 1 is transferred to an extruder 4. The aluminum wire 1 transferred to the extruder 4 is extruded into a rolled board whose section has a long oval shape with two flat portions H and two rounded portions R and in which a plurality of flow passages F is provided to allow flow of coolant. After that, zinc is coated on a surface of the rolled board, and then the rolled board is wound around a winding bobbin 10 after final treatments.

When making a heat exchanger, a plurality of such heat exchanger tubes are laminated together with pins. The heat exchanger tube is joined with the pin by means of hot-melt adhesion using glue. That is to say, the glue is melt during the joining process and then flowed into a joining area between the tube and the pin due to capillary phenomenon and surface tension to join the tube and the pin with each other.

In the process of making a conventional heat exchanger, after the heat exchanger tube and the pin are assembled, a mixture solution in which water and flux are mixed should be sprayed and coated before brazing. If such a mixture solution is not used, an oxide film formed on the aluminum is cracked due to the difference of thermal expansion coefficients of the aluminum and the oxide film, so the aluminum surface is oxidized.

However, the conventional flux coating method consumes a large amount of flux due to moisture since the flux is sprayed in a liquid state mixed with water. In addition, a large amount of flux coated on the heat exchanger tube generates moisture while being heated in a heating furnace, thereby corroding parts in the heating furnace. Also, the flux may be coated excessively in regions other than the joining area and then penetrated into a coupling surface of a jig and the heat exchanger in a melt state. Accordingly, when the heat exchanger is taken out from the heating furnace, the jig is separated while the flux is solidified, so a jig mark is formed on the heat exchanger. In a severe case, the heat exchanger should be wasted since the heat exchanger is adhered to the jig.

In order to solve the defects of the above flux coating and thus ensure more efficient joining process of the heat exchanger tube, many techniques for effectively coating flux on the heat exchanger tube have been proposed. For example, Japanese Laid-open Patent Publication H7-100635 (hereinafter, referred to as a first document) discloses a technique of coating a liquid paste, containing soldering alloy powder and flux in mixture, on a surface of a part to be joined, and then drying the liquid paste. Also, Japanese Laid-open Patent Publication H14-194468 (hereinafter, referred to as a second document) discloses a technique of cladding a coating material containing soldering alloy on at least one surface of a core made of aluminum or its alloy, then forming a flux layer thereon, and then extruding it.

However, the coating method of the first document needs a separate drying process since it uses a liquid paste. In addition, due to bad adhesive force to a part, the coating may be separated to deteriorate junction when an additional handling process is conducted. Here, in case the coating is irregular, erosion may occur in a region where the coating is excessive, and irregular junction occurs in a region where the coating is deficient.

In addition, the coating method of the second document has problems that the flux is stuck to an extruding roller during the extruding process, so the extruding itself becomes difficult.

Moreover, the coating methods of the above documents are all undesirable since dust occurring in the flux coating process deteriorates working environment, productivity according to the process time is not efficient, and thickness and amount of coated flux are not easily controlled.

### SUMMARY OF THE INVENTION

The present invention is designed to solve the problems of the prior art, and therefore the present invention is directed to shortening a flux coating time onto a heat exchanger tube, reducing a coating amount of flux powder, and ensuring uniform flux coating such that the heat exchanger tube may be joined without an error during the joining process.

In one aspect of the present invention, there is provided a method for flux coating of a heat exchanger tube made of aluminum, which includes (A) forming a first coating layer by dipping the heat exchanger tube in a storage tank containing a mixture of binder and solvent to coat the mixture on a surface of the heat exchanger tube; (B) forming a second coating layer by spraying flux powder to the surface of the heat exchanger tube on which the first coating layer is formed; and (C) controlling a thickness of the heat exchanger tube on which the second coating layer is formed.

Preferably, the flux powder is any one selected from the group consisting of K-Al-F materials, K-Zn-F materials, and K-Si-F materials.

Also preferably, the binder is any one selected from the group consisting of methacryl, acryl, urethane, and epoxy materials.

Preferably, the solvent is any one or a mixture of at least two selected from the group consisting of 2-propanol, 1-propanol, ethylene glycol, and ethyl ether.

At this time, it is preferred that the binder satisfies 0.1 to 10 wt % based on a weight of the total composition containing the flux powder, the binder and the solvent, and the flux powder satisfies 10 to 50 wt % based on the weight of the total composition containing the flux powder, the binder and the solvent.

Preferably, the flux powder is coated in a content of 1 to 300 g/m².

The method for flux coating of a heat exchanger tube according to the present invention may further include a drying step for removing the solvent from the second coating layer by heating the thickness-controlled heat exchanger tube to 150° C. or below.

Preferably, after the drying step, the second coating layer has a thickness of 0.5 to 20 μm

Also preferably, before coating, the heat exchanger tube is a PFC (Parallel Flow Condenser) tube.

In another aspect of the present invention, there is also provided an apparatus for flux coating of a heat exchanger made of aluminum, which includes a storage tank for receiving a mixture of binder and solvent and coating a first coating layer on a surface of the heat exchanger tube by dipping the heat exchanger tube therein; a spraying means for forming a second coating layer by spraying flux powder on the surface of the heat exchanger tube on which the first coating layer is formed; and a thickness controlling means composed of a pair of first rollers facing each other with a predetermined gap therebetween so as to control a thickness of the second coating layer.

The apparatus may further include a drying device for removing the solvent from the coating layer on the surface of the heat exchanger tube by applying heat at 150° C. or below to the thickness-controlled heat exchanger tube.

Also, the apparatus may further include an excessive mixture removing means composed of a pair of second rollers facing each other with a predetermined gap therebetween so as to remove an excessive mixture existing on the surface of the heat exchanger tube having the first coating layer.

Preferably, the spraying means is provided in a furnace for heating the heat exchanger tube.

### BRIEF DESCRIPTION OF THE DRAWINGS

Other objects and aspects of the present invention will become apparent from the following description of embodiments with reference to the accompanying drawing in which:

FIG. 1 illustrates an extrusion process of a conventional heat exchanger tube;

FIG. 2 is a perspective view showing a conventional heat exchanger tube;

FIG. 3 illustrates a flux coating process according to a preferred embodiment of the present invention; and

FIG. 4 is a sectional view showing a flux-coated heat exchanger tube according to a preferred embodiment of the present invention.

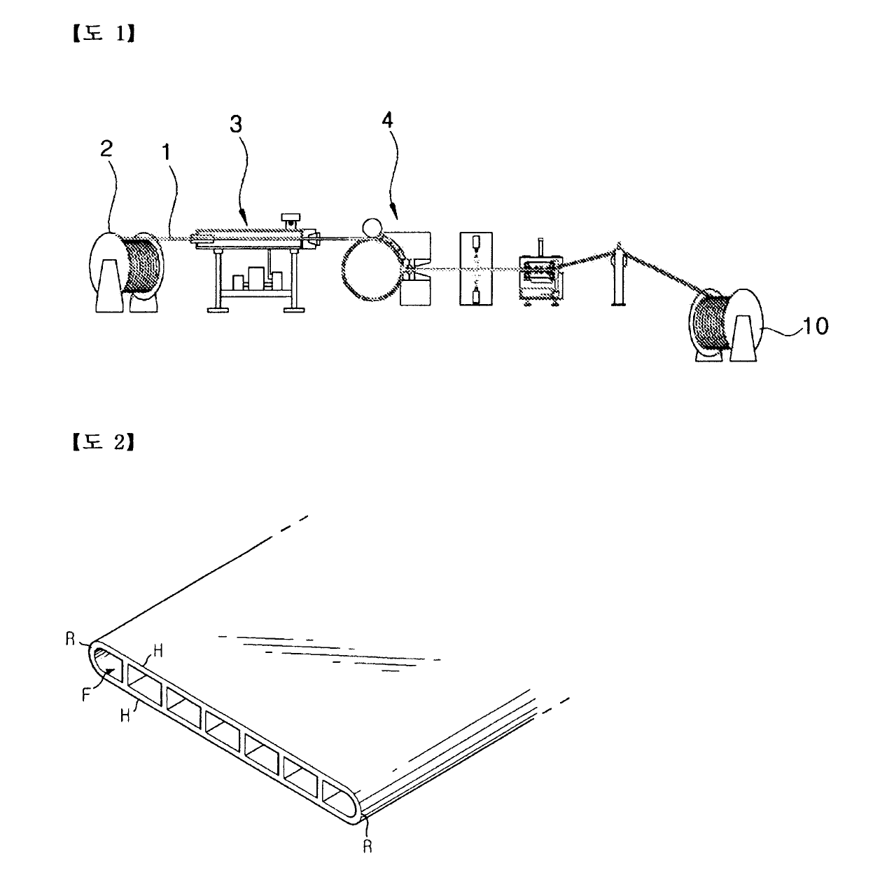

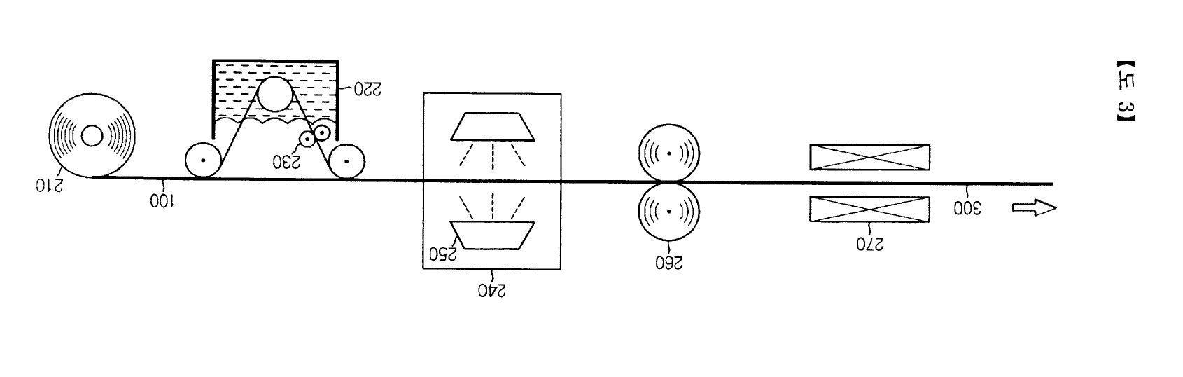

### REFERENCE NUMERALS OF ESSENTIAL PARTS IN THE DRAWINGS

100: heat exchanger tube 210: unwinding bobbin

220: storage tank

230: excessive mixture removing roller

240: furnace 250: spraying unit

260: thickness control roller 270: drying device

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

A heat exchanger tube according to an embodiment of the present invention is a rolled board having a plurality of flow passages by extrusion, and this rolled board is successively wound around a bobbin for packaging. The heat exchanger tube is flux-coated before becoming a final product.

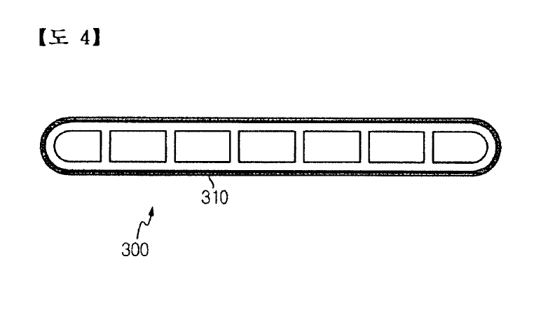

The flux coating process of the heat exchanger tube is now explained as follows with reference to FIG. 3.

As shown in FIG. 3, the heat exchanger tube 100 is a PFC (Parallel Flow Condenser) tube made of aluminum, and the heat exchanger tube 100 is initially unwound from an unwinding bobbin 210 at a predetermined speed and finally successively wound around a winding bobbin (not shown) into a product.

The PFC tube 100 is made into a heat exchanger tube 300 on which flux is coated, by using a flux coating apparatus shown in FIG. 3. That is to say, the flux coating apparatus according to the present invention includes a storage tank 220, an excessive mixture removing roller 230, a furnace 240, a spraying means 250, a thickness control roller 260 and a drying device 270.

The storage tank 220 is a reservoir receiving a mixture in which binder and solvent are mixed. The mixture is coated on a surface of the heat exchanger tube 100 that moves along an advancing direction of the process (see an arrow of FIG. 3), thereby forming a first coating layer.

The excessive mixture removing roller 230 is composed of a pair of rollers arranged to face each other with a predetermined gap therebetween, and the firstly-coated heat exchanger tube passes through the gap to remove any mixture excessively coated on the surface of the heat exchanger tube.

The furnace 240 has the spraying means 250 therein, and the spraying means 250 sprays flux powder to the firstly-coated heat exchanger tube to secondly coat the surface of the heat exchanger tube. Here, the spraying means 250 is provided in the furnace 240 to prevent the sprayed flux powder from scattering out of the furnace 240.

The thickness control roller 260 is composed of a pair of rollers arranged to face each other with a predetermined gap therebetween, and the thickness control roller 260 suitably controls a thickness of a coating layer of the secondly-coated heat exchanger tube that passes through the gap. For this purpose, the pair of rollers are preferably movable up and down to adjust the gap.

The drying device 270 applies heat at 150° C. or below to the heat exchanger tube having the thickness-controlled coating layer so as to remove the solvent.

Hereinafter, the process of executing flux coating on a heat exchanger tube using the flux coating apparatus according to the present invention is explained in detail with reference to FIG. 3.

First, the heat exchanger tube 100 is unwound from the unwinding bobbin 210 at a predetermined speed such that the heat exchanger tube may subsequently pass through the flux coating apparatus 220 to 270.

Then, the heat exchanger tube 100 successively unwound from the unwinding bobbin 210 is dipped into the mixture while passing through the storage tank 220 containing the mixture of binder and solvent. At this time, by the dipping, the mixture is coated on the surface of the heat exchanger tube, and thus a first coating layer is formed on the surface of the heat exchanger tube.

Here, the solvent is preferably any one or a mixture of at least two selected from the group consisting of 2-propanol, 1-propanol, ethylene glycol, and ethyl ether.

After passing through the storage tank 220, the heat exchanger tube 100 passes through the excessive mixture removing roller 230 so as to remove any mixture excessively coated on the surface of the heat exchanger tube 100. At this time, the excessive mixture removing roller 230 rolls the surface of the heat exchanger tube at a predetermined pressure.

After that, the heat exchanger tube free from excessive mixture is moved into the furnace 240 provided with the spraying means 250. At this time, the spraying means 250 sprays flux powder to the heat exchanger tube having the first coating layer, and the sprayed flux powder is coated on the mixture that forms the first coating layer, and then mixed with the mixture. The flux powder and the mixture, mixed as above, forms a second coating layer on the surface of the heat exchanger tube. Here, the flux powder is sprayed in the furnace 240, thereby restraining scattering of dust to outside.

In this embodiment, the binder forming the first coating layer is preferably any one selected from the group consisting of methacryl, acryl, urethane, and epoxy materials, and the binder is preferably in the range of 0.1 to 10 wt %, more preferably 0.5 to 5 wt %, based on a weight of the total composition containing the flux powder, the binder and the solvent. If the content of the binder is less than 0.1 wt %, viscosity of the flux is lowered, so an adhesion to the heat exchanger tube is deteriorated. If the content of the binder exceeds 10 wt %, a manufacture cost is increased.

In addition, the flux powder forming the second coating layer is preferably any one selected from the group consisting of K-Al-F materials, K-Zn-F materials, and K-Si-F materials, more preferably K-Zn-F material. Here, the flux powder is preferably in the range of 10 to 50 wt % based on the weight of the total composition containing the flux powder, the binder and the solvent. If the content of the flux powder is less than 10 wt %, an adhesion of the flux to the surface of the heat exchanger tube may be lowered. If the content of the flux powder exceeds 50 wt %, a manufacture cost is increased.

Then, the heat exchanger tube having the second coating layer is moved to the thickness control roller 260. At this time, the thickness control roller 260 closely adheres the second coating layer to the heat exchanger tube satisfactorily and at the same time rolls the heat exchanger tube at a predetermined pressure to make the thickness uniform.

After that, the heat exchanger tube having passed through the thickness control roller 260 is moved to the drying device 270. At this time, the drying device 270 applies heat at 150° C. or below to the heat exchanger tube for 1 to 100 seconds so as to remove the solvent from the composition of the coating layer formed on the surface of the heat exchanger tube.

Here, the coating layer free from the solvent preferably has a thickness of 0.5 to 20 μm. If the thickness of the coating layer is less than 0.5 μm, an amount of flux per unit area is deficient, so the adhesion to the heat exchanger tube is deteriorated. If the thickness exceeds 20 μm, an amount of flux per unit area becomes excessive, so remaining flux flows down during the adhering process of the heat exchanger tube, which may cause deteriorated appearance of the heat exchanger tube.

Then, the heat exchanger tube 300 having passed through the drying device 270 is successively wound around a winding bobbin (not shown) and becomes a product. At this time, the wound heat exchanger tube 300 has a coating layer 310 of a predetermined thickness, as shown in FIG. 4.

In this embodiment, the heat exchanger tube having passed through the thickness control roller 260 may also be not moved to the drying device 270 but naturally dried and then wound around the winding bobbin (not shown) to be a product.

At this time, in case of natural drying, an adhered amount of flux powder per unit area is preferably 1 to 300 g/m², more preferably 3 to 100 g/m². If the adhered amount is less than 1 g/m², the adhered amount is deficient, so the flux cannot perform its role. If the adhered amount exceeds 300 g/m², the adhered amount is excessive, so remaining flux may flow down during the adhering process of the heat exchanger tube, thereby deteriorating appearance of the heat exchanger tube.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

As described above, the method and apparatus for flux coating of a heat exchanger tube according to the present invention has advantages that a coating amount of flux may be reduced and a flux coating layer may be uniformly formed on the entire surface of the heat exchanger tube, since a mixture of binder and solvent is coated in advance.

In addition, the present invention allows successive coating, thereby shortening a process time for the flux coating. Improvement of productivity is also expected.

Moreover, the excessive mixture removing roller and the thickness control roller facilitate removing any excessive mixture and controlling a thickness of a coating layer, and also the present invention ensures good adhesion of the flux coated on the heat exchanger tube.

What is claimed is:

1. A method for flux coating of a heat exchanger tube made of aluminum, comprising:
(A) forming a first coating layer by dipping the heat exchanger tube in a storage tank containing a mixture of binder and solvent to coat the mixture on a surface of the heat exchanger tube;
(B) forming a second coating layer by spraying flux powder to the surface of the heat exchanger tube on which the first coating layer is formed; and
(C) controlling a thickness of the heat exchanger tube on which the second coating layer is formed.

2. The method for flux coating of a heat exchanger tube according to claim 1,
wherein the flux powder is any one selected from the group consisting of K-Al-F materials, K-Zn-F materials, and K-Si-F materials.

3. The method for flux coating of a heat exchanger tube according to claim 2,
wherein the binder is any one selected from the group consisting of methacryl, acryl, urethane, and epoxy materials.

4. The method for flux coating of a heat exchanger tube according to claim 3,
wherein the solvent is any one or a mixture of at least two selected from the group consisting of 2-propanol, 1-propanol, ethylene glycol, and ethyl ether.

5. The method for flux coating of a heat exchanger tube according to claim 4,
wherein the binder satisfies 0.1 to 10 wt % based on a weight of the total composition containing the flux powder, the binder and the solvent, and the flux powder satisfies 10 to 50 wt % based on the weight of the total composition containing the flux powder, the binder and the solvent.

6. The method for flux coating of a heat exchanger tube according to claim 5,
wherein the flux powder is coated in a content of 1 to 300 g/m².

7. The method for flux coating of a heat exchanger tube according to claim 6, further comprising:
a drying step for removing the solvent from the second coating layer by heating the thickness-controlled heat exchanger tube to 150° C. or below.

8. The method for flux coating of a heat exchanger tube according to claim 7,
wherein, after the drying step, the second coating layer has a thickness of 0.5 to 20 μm

9. The method for flux coating of a heat exchanger tube according to claim 1,
wherein, before coating, the heat exchanger tube is a PFC (Parallel Flow Condenser) tube.

10. An apparatus for flux coating of a heat exchanger made of aluminum, comprising:
a storage tank for receiving a mixture of binder and solvent and coating a first coating layer on a surface of the heat exchanger tube by dipping the heat exchanger tube therein;
a spraying means for forming a second coating layer by spraying flux powder on the surface of the heat exchanger tube on which the first coating layer is formed; and
a thickness controlling means composed of a pair of first rollers facing each other with a predetermined gap therebetween so as to control a thickness of the second coating layer.

11. The apparatus for flux coating of a heat exchanger tube according to claim 10, further comprising:
a drying device for removing the solvent from the coating layer on the surface of the heat exchanger tube by applying heat at 150° C. or below to the thickness-controlled heat exchanger tube.

12. The apparatus for flux coating of a heat exchanger tube according to claim 11, further comprising:
an excessive mixture removing means composed of a pair of second rollers facing each other with a predetermined gap therebetween so as to remove an excessive mixture existing on the surface of the heat exchanger tube having the first coating layer.

13. The apparatus for flux coating of a heat exchanger tube according to claim 12,
wherein the spraying means is provided in a furnace for heating the heat exchanger tube.
